(19) United States
(12) Patent Application Publication
(10) Pub. No.: US 2026/0282040 A1
(43) Pub. Date: Sep. 17, 2026

(54) CHANNEL OCCUPANCY TIME (COT) SHARING OVER AN UNLICENSED SIDELINK CHANNEL

(71) Applicant: Lenovo (Singapore) Pte. Ltd., Singapore (SG)

(72) Inventors: Alexander Golitschek Edler von Elbwart, Darmstadt (DE); Karthikeyan GANESAN, Nauheim (DE)

(21) Appl. No.: 19/167,698

(22) PCT Filed: Mar. 29, 2024
(86) PCT No.: PCT/IB2024/053112

§ 371 Date: Sep. 22, 2025

Related U.S. Application Data
(60) Provisional application No. 63/493,618, filed on Mar. 31, 2023.

(51) Int. Cl. H04W 72/25; H04W 74/08

(52) U.S. Cl. CPC H04W 72/25; H04W 74/0866

(57) ABSTRACT

Various aspects of the present disclosure relate to channel occupancy time (COT) sharing for sidelink communications over unlicensed channels. For example, a COT initiating UE may modify COT sharing information signaled or transmitted to target UEs to include certain types of identifiers associated with synchronization reference (SyncRef) UEs, such as a Sidelink Synchronization Signal Identifier (SLSS ID) that identifies a UE as a SyncRef UE. The COT initiating UE may signal one or more SLSS IDs as additional IDs within or as part of COT sharing information. Being identified in the COT sharing information, the SyncRef UE can access the shared COT and transmit synchronization data, such as sidelink synchronization signal blocks (S-SSBs).

### CROSS REFERENCE TO RELATED APPLICATIONS

This application claims priority to U.S. Provisional Patent Application No. 63/493,618, filed on Mar. 31, 2023, entitled CHANNEL OCCUPANCY TIME (COT) SHARING OVER AN UNLICENSED SIDELINK CHANNEL, which is incorporated by reference in its entirety.

### TECHNICAL FIELD

The present disclosure relates to wireless communications, and more specifically to sharing a channel occupancy time (COT) for an unlicensed sidelink channel.

### BACKGROUND

A wireless communications system may include one or multiple network communication devices, such as base stations, which may be otherwise known as an eNodeB (eNB), a next-generation NodeB (gNB), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

For new radio (NR) applications, such as vehicle-to-everything (V2X) deployments and similar applications described herein, a UE may transmit information that supports synchronization between UEs (e.g., between vehicles) over a sidelink channel, which enables direct communications between UEs. The UE may serve as a synchronization reference (SyncRef) UE, and the information may be carried on sidelink synchronization signal blocks (S-SSBs). The S-SSBs may comprise a Physical Sidelink Broadcast Channel (PSBCH), a Sidelink Primary Synchronization Signal (S-PSS) and a Sidelink Secondary Synchronization Signal (S-SSS).

Other UEs, such as those nearby to a SyncRef UE, may receive S-SSB transmissions, and synchronize to the SyncRef UE. In doing so, the other UEs can match a sidelink timing reference with the SyncRef UE and establish sidelink communication with the SyncRef UE and other nearby UEs.

### SUMMARY

The present disclosure relates to methods, apparatuses, and systems that support COT sharing for sidelink communications over unlicensed channels. For example, a COT initiating UE may modify COT sharing information signaled or transmitted to target UEs to include certain types of identifiers associated with synchronization reference (SyncRef) UEs, such as a Sidelink Synchronization Signal Identifier (SLSS ID) that identifies a UE as a SyncRef UE. The COT initiating UE may signal one or more SLSS IDs as additional IDs within or as part of the COT sharing information. Being identified in the COT sharing information, the SyncRef UE can access the shared COT and transmit synchronization data, such as sidelink synchronization signal blocks (S-SSBs).

Some implementations of the method and apparatuses described herein may further include a UE, comprising at least one memory and at least one processor coupled with the memory and configured to cause the UE to receive an indication of a shared COT with a sidelink channel, wherein the indication includes a set of SLSS IDs, determine that an SLSS ID of the UE matches one or more SLSS IDs of the set of SLSS IDs, and access the sidelink channel based at least in part on the determination.

In some implementations of the method and apparatuses described herein, the indication of the shared COT is received via a medium access control (MAC) control element, sidelink control information (SCI), or resources within a physical sidelink shared channel (PSSCH).

In some implementations of the method and apparatuses described herein, the processor is further configured to cause the UE to transmit, over the sidelink channel, one or more S-SSBs or parts thereof, and access the sidelink channel associated with the shared COT based at least in part on a Type 2 or a sub-type of the Type 2 channel access procedure.

In some implementations of the method and apparatuses described herein, the UE is a synchronization reference (SyncRef) UE, and the processor is configured to cause the synchronization reference UE to transmit S-SSBs or parts thereof over the sidelink channel.

In some implementations of the method and apparatuses described herein, the indication of the shared COT includes a respective in-coverage indicator (I_{IC}) for each of the one or more SLSS IDs of the set of SLSS IDs, and wherein the processor is configured to cause the UE to access the sidelink channel based at least in part on a match of a combination of the SLSS ID of the UE and an in-coverage indicator (I_{IC}) for the UE to one or more combinations of SLSS IDs and in-coverage indicators (I_{IC}) received in the indication of the shared COT.

In some implementations of the method and apparatuses described herein, the UE is an out-of-coverage SyncRef UE, and the processor is configured to cause the synchronization reference UE to transmit S-SSBs or parts thereof over the sidelink channel.

In some implementations of the method and apparatuses described herein, the indication of the shared COT includes an identifier representing a list of SLSS IDs associated with a set of SyncRef UEs authorized to access the sidelink channel for transmission of S-SSBs or parts thereof.

In some implementations of the method and apparatuses described herein, the processor is configured to cause the UE to receive a radio resource control (RRC) message comprising the list of SLSS IDs associated with a set of synchronization reference UEs.

In some implementations of the method and apparatuses described herein, the indication of the shared COT includes a flag field that indicates whether to access the sidelink channel for transmission of S-SSBs or parts thereof.

Some implementations of the method and apparatuses described herein may further include a method performed by a UE, the method comprising receiving an indication of a shared COT associated with a sidelink channel, wherein the indication includes a set of SLSS IDs, determining that an SLSS ID of the UE matches one or more SLSS IDs of the set of SLSS IDs, and accessing the sidelink channel based at least in part on the determination.

In some implementations of the method and apparatuses described herein, the indication of the shared COT is received via a MAC control element, SCI, or resources within a PSSCH.

In some implementations of the method and apparatuses described herein, the method further comprises transmitting, over the sidelink channel, one or more S-SSBs or parts thereof, and accessing the sidelink channel associated with the shared COT based at least in part on a Type 2 or a sub-type of the Type 2 channel access procedure.

In some implementations of the method and apparatuses described herein, the UE is a SyncRef UE that transmits S-SSBs or parts thereof over the sidelink channel.

In some implementations of the method and apparatuses described herein, the indication of the shared COT includes a respective in-coverage indicator (I_{IC}) for each of the one or more SLSS IDs of the set of SLSS IDs, and wherein the UE accesses the sidelink channel based at least in part on a match of a combination of the SLSS ID of the UE and an in-coverage indicator (I_{IC}) for the UE to one or more combinations of SLSS IDs and in-coverage indicators (I_{IC}) received in the indication of the shared COT.

In some implementations of the method and apparatuses described herein, the UE is an out-of-coverage SyncRef UE that transmits S-SSBs or parts thereof over the sidelink channel.

In some implementations of the method and apparatuses described herein, the indication of the shared COT includes an identifier representing a list of SLSS IDs associated with a set of SyncRef UEs authorized to access the sidelink channel for transmission of S-SSBs or parts thereof.

In some implementations of the method and apparatuses described herein, the method further comprises receiving an RRC message comprising the list of SLSS IDs associated with a set of SyncRef UEs.

In some implementations of the method and apparatuses described herein, the indication of the shared COT includes a flag field that indicates whether to access the sidelink channel for transmission of S-SSBs or parts thereof.

Some implementations of the method and apparatuses described herein may further include a UE comprising at least one memory and at least one processor coupled with the memory and configured to cause the UE to initiate a COT within an unlicensed channel, and transmit an indication of a shared COT that includes one or more SLSS IDs.

In some implementations of the method and apparatuses described herein, the indication of the shared COT includes a respective in-coverage indicator (I_{IC}) for each of the one or more SLSS IDs of the set of SLSS IDs.

In some implementations of the method and apparatuses described herein, the indication of the shared COT includes an identifier that represents a list of SLSS IDs associated with SyncRef UEs authorized to access the COT for transmission of S-SSBs or parts thereof.

Some implementations of the method and apparatuses described herein may further include a method performed by a UE, the method comprising initiating a COT within an unlicensed channel and transmitting an indication of a shared COT that includes one or more SLSS IDs.

In some implementations of the method and apparatuses described herein, the indication of the shared COT includes a respective in-coverage indicator (I_{IC}) for each of the one or more SLSS IDs of the set of SLSS IDs.

In some implementations of the method and apparatuses described herein, the indication of the shared COT includes an identifier that represents a list of SLSS IDs associated with SyncRef UEs authorized to access the COT for transmission of S-SSBs or parts thereof.

Some implementations of the method and apparatuses described herein may further include a processor for wireless communication, comprising at least one controller coupled with at least one memory and configured to cause the processor to initiate a COT within an unlicensed channel and transmit an indication of a shared COT that includes one or more SLSS IDs.

### BRIEF DESCRIPTION OF THE DRAWINGS

FIG. 1 illustrates an example of a wireless communications system that supports COT sharing for an unlicensed sidelink channel in accordance with aspects of the present disclosure.

FIG. 2 illustrates an example of a wireless communications system that supports sharing a COT with a synchronization reference UE in accordance with aspects of the present disclosure.

FIGS. 3A-3B illustrate examples of wireless communications systems that support transmitting information over a shared COT in accordance with aspects of the present disclosure.

FIG. 4 illustrates an example of a block diagram of a device that supports COT sharing for an unlicensed sidelink channel in accordance with aspects of the present disclosure.

FIG. 5 illustrates a flowchart of a method that supports sharing a COT with a synchronization reference UE in accordance with aspects of the present disclosure.

FIG. 6 illustrates a flowchart of a method that supports transmitting information over a shared COT in accordance with aspects of the present disclosure.

### DETAILED DESCRIPTION

As described herein, when a first UE (e.g., a responding UE) receives an indication of a shared COT from a second UE (e.g., a COT initiating UE that initiated the COT using a Type 1 channel access procedure), the first UE can transmit S-SSBs within one or more resource block (RB) sets that correspond to the shared COT.

The first UE may be a receiving UE, such as a UE that is a target of the indication of the shared COT via a Physical Sidelink Control Channel (PSCCH) or Physical Sidelink Shared Channel (PSSCH) transmission by the COT initiating UE. The first UE may also be identified by one or more identifiers (IDs), when COT sharing information includes the additional information along with other information (e.g., source and destination IDs of the PSCCH/PSSCH transmission).

For example, the COT initiating UE may indicate a COT sharing and address another UE by transmitting PSCCH/PSSCH to target the UE, where the source/destination IDs are in the PSCCH/PSSCH and are specific to a sidelink session.

However, in some cases, one or more SyncRef UEs may be expected to transmit S-SSBs within a shared COT, but are not addressed (e.g., not identified, or targeted) by the COT initiating UE. In such cases, to access the shared COT, the SyncRef UEs may have to perform a Type 1 channel access procedure, which can fail and/or exhaust significant resources, in contrast to a Type 2 channel access procedure, which is less likely to fail and is more efficient for providing access to a shared COT.

Thus, the technology described herein may facilitate SyncRef UEs to utilize a COT shared by a COT initiating UE, such that the SyncRef UEs may avoid performing a channel access procedure (e.g., the Type 1 channel access procedure), may perform the Type 2 channel access procedure to access the shared COT.

The technology, in some embodiments, may facilitate COT sharing information signaled or transmitted to target UEs to include certain types of identifiers associated with SyncRef UEs, such as a Sidelink Synchronization Signal Identifier (SLSS ID) that identifies a UE as a SyncRef UE. For example, the COT initiating UE may signal one or more SLSS IDs as additional IDs within or as part of COT sharing information.

Thus, the COT initiating UE can target one or more SyncRef UEs based on their synchronization identifiers (e.g., SLSS IDs), enabling the SyncRef UEs to access a shared COT without being specifically addressed by the source IDs or destination IDs for sidelink channel transmissions (e.g., by PSCCH or PSSCH) within transmitted COT sharing information, among other benefits.

Aspects of the present disclosure are described in the context of a wireless communications system. Aspects of the present disclosure are further illustrated and described with reference to device diagrams and flowcharts.

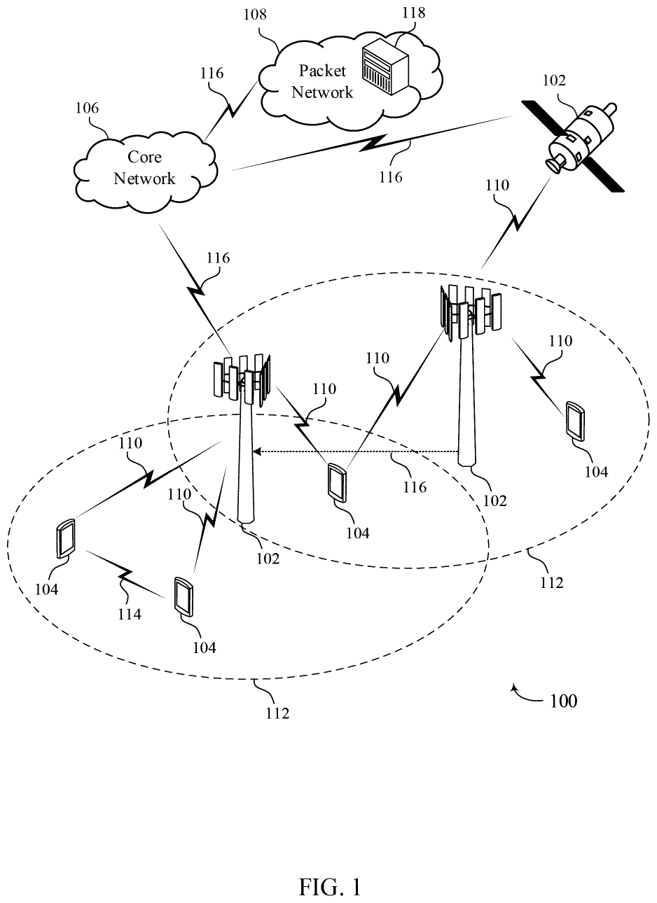

FIG. 1 illustrates an example of a wireless communications system 100 that supports COT sharing for an unlicensed sidelink channel in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IOT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling and may each be at least partially controlled by the CU 160.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N2, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communication system 100 (e.g., time resources (e.g., symbols, slots, subframes, frames, or the like) or frequency resources (e.g., subcarriers, carriers)) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.12 GHz-24.25 GHz), FR4 (52.6 GHz-114.25 GHz), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., p=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

As described herein, in some embodiments, a wireless communications system may facilitate and/or enable the sharing of a COT with SyncRef UEs based on identifiers specific to the synchronization operations of the UEs.

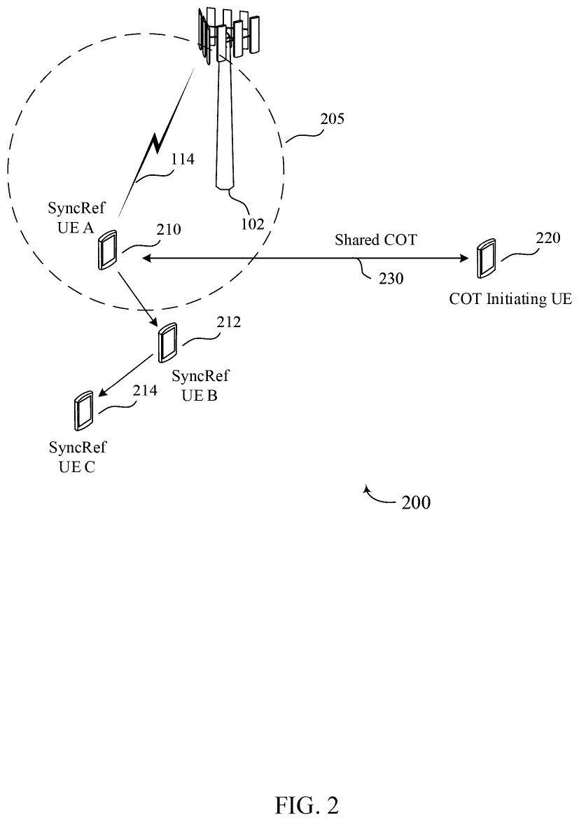

FIG. 2 illustrates an example of a wireless communications system 200 that supports sharing a COT with a synchronization reference UE in accordance with aspects of the present disclosure. A UE 210 (e.g., SyncRef UE A), within a coverage area 205 of a network, may be configured by the network to become a SyncRef UE and/or may determine itself to become a SyncRef UE when in or out of the network coverage 205.

When the UE 210 becomes a SyncRef UE, the UE 210 can trigger S-SSB transmissions based on a timing reference provided by its respective synchronization reference entity (e.g., the network entity 102 or another UE 104). For example, the UE 210 utilizes the network entity 202 as its synchronization reference entity, whereas an out of coverage UE 212 (e.g., SyncRef UE B) utilizes the UE 210 (SyncRef UE A) as its synchronization reference entity, and a UE 214 (e.g., SyncRef UE C) utilizes the UE 212 (SyncRef UE B) as its synchronization reference entity.

Alternatively or additionally, a reference entity for obtaining a timing reference may be a node in a global navigation satellite system (GNSS).

The UE 210, in the coverage area 205 of the network, may be configured by the network to transmit (or not transmit) S-SSBs over a sidelink. In some cases, such as when the UE 210 is configured by the network, the UE 210 may send S-SSBs regardless of whether there is data to send over the sidelink.

As described herein, a COT initiating UE 220 may share a COT 230 with one or more of the SyncRef UEs, such as the UE 210. Thus, the COT initiating UE 220 can initiate the COT 230, and the UE 210 can access and the share the COT for various transmissions, such as S-SSBs transmitted to other nearby UEs.

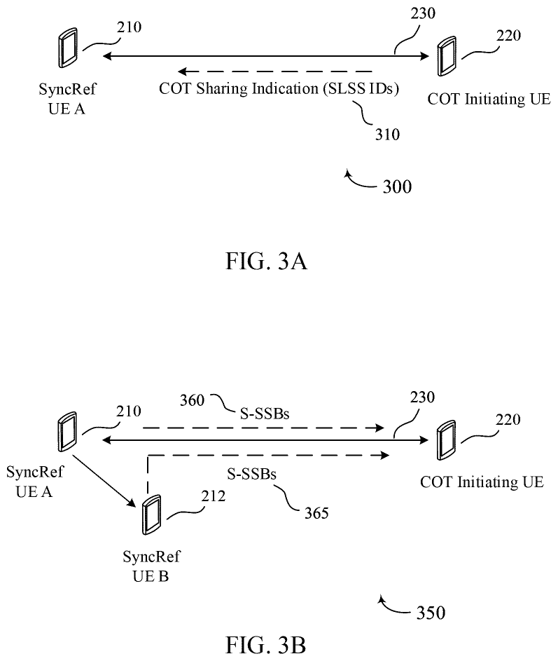

FIGS. 3A-3B illustrate examples of wireless communications systems that support transmitting information over a shared COT in accordance with aspects of the present disclosure.

For example, as depicted in a wireless communications system 300 of FIG. 3A, the COT initiating UE 220 transmits an indication of COT sharing (e.g., a COT sharing indication) that includes COT sharing information 310. The COT sharing information 310 may include SLSS IDs for one or more SyncRef UEs (e.g., a set of SLSS IDs), such as the UE 210, the UE 212, the UE 214, and so on. The COT sharing information 310 may be conveyed via a MAC control element (MAC CE), by information included in sidelink control information (SCI), such as a 1^{st} stage SCI format or a 2^{nd} stage SCI format, and/or by specific resources within the PSSCH.

In some cases, the COT sharing information 310 may include respective in-coverage indicators (I_{ICs}) mapped to the SLSS IDs of the set of SLSS IDs. The in-coverage indicators (I_{ICs}) can disambiguate the specific SyncRef UEs, such as identify a unique UE from two UEs that share a common SLSS ID (one being in-coverage and one being out-of-coverage).

Further, the COT sharing information 310 may include one or more additional SLSS IDs. For example, the COT sharing information 310 can identify other SyncRef UEs that are associated with a SyncRef UE that is targeted by the COT initiating UE 220.

The COT sharing information 310 may include an identifier representing a list of SLSS IDs associated with a set of synchronization reference (SyncRef) UEs authorized to access the sidelink channel and/or a flag field that indicates the channel can be accessed by SyncRef UEs. In some cases, a UE can be configured, such as via an RRC message, with a list of SLSS IDs associated with a set of synchronization reference UEs and/or with information that maps to a flag or flags within the COT sharing information 310.

For example, a flag field that indicates the channel can be accessed by SyncRef UEs may allow any SyncRef UE detecting the flag field indication to utilize a COT 230 shared by the COT initiating UE 210.

As described herein, a SyncRef UE may utilize a COT 230 shared by the COT initiating UE 210 by a Type 2 channel access procedure (e.g., such as one or more sub-types 2A, 2B, 2C) to access the shared COT 230. In some cases, a Type 2 channel access procedure can be characterized by having a deterministic time duration spanned by sensing slots that are sensed to be idle before a downlink transmission(s), e.g., with a fixed time duration, as opposed to a Type 1 channel access procedures including a random component. For example, the deterministic time duration may be 25 μs, 16 μs, or 0 μs (no sensing of the channel before the transmission) for sub-types 2A, 2B, 2C, respectively.

The SyncRef UE, having access to the shared COT 230, can then transmit one or more S-SSBs. As described herein, transmitting one or more S-SSBs can include transmitting PSBCH, S-PSS and S-SSS, or parts thereof. For example, in some cases, the SyncRef UE may transmit S-PSS and S-SSS, but no PBSCH.

For example, as depicted in a wireless communications system 350 of FIG. 3B, the UE 210 (e.g., the SyncRef UE A) can determine that an SLSS ID of the UE 210 matches one or more SLSS IDs of the set of SLSS IDs within the COT sharing information 310 (see FIG. 3A), access the sidelink channel based at least in part on the determination, and transmit the S-SSBs 360.

Similarly, the out-of-coverage UE 212, which is associated to the UE 210 (e.g., the UE 210 is its synchronization reference entity), can also determine that an SLSS ID of the UE 212 matches one or more SLSS IDs of the set of SLSS IDs within the COT sharing information 310, access the sidelink channel based at least in part on the determination, and transmit its own S-SSBs 365.

Thus, in various embodiments, a COT initiating UE can transmit an indication of COT sharing that includes identifiers specific or associated with other UEs acting as SyncRef UEs, enabling the SyncRef UEs to access a shared COT and transmit synchronization data (e.g., S-SSBs) over the shared COT.

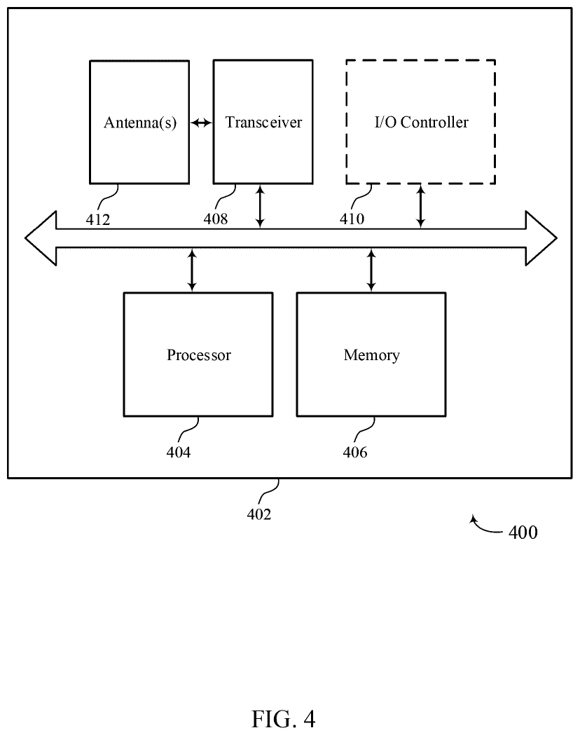

FIG. 4 illustrates an example of a block diagram 400 of a device 402 that supports COT sharing for an unlicensed sidelink channel in accordance with aspects of the present disclosure. The device 402 may be an example of a network entity 102 or UE 104 as described herein. The device 402 may support wireless communication with one or more network entities 102, UEs 104, or any combination thereof. The device 402 may include components for bi-directional communications including components for transmitting and receiving communications, such as a processor 404, a memory 406, a transceiver 408, and an I/O controller 410. These components may be in electronic communication or otherwise coupled (e.g., operatively, communicatively, functionally, electronically, electrically) via one or more interfaces (e.g., buses).

The processor 404, the memory 406, the transceiver 408, or various combinations thereof or various components thereof may be examples of means for performing various aspects of the present disclosure as described herein. For example, the processor 404, the memory 406, the transceiver 408, or various combinations or components thereof may support a method for performing one or more of the operations described herein.

In some implementations, the processor 404, the memory 406, the transceiver 408, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 404 and the memory 406 coupled with the processor 404 may be configured to perform one or more of the functions described herein (e.g., executing, by the processor 404, instructions stored in the memory 406).

For example, the processor 404 may support wireless communication at the device 402 in accordance with examples as disclosed herein. The processor 404 may be configured as or otherwise support a means for receiving an indication of a shared COT associated with a sidelink channel, wherein the indication includes a set of SLSS IDs, determining that an SLSS ID of the UE matches one or more SLSS IDs of the set of SLSS IDs, and accessing the sidelink channel based at least in part on the determination.

As another example, the processor 404 may support wireless communication at the device 402 in accordance with examples as disclosed herein. The processor 404 may be configured as or otherwise support a means for initiating a COT within an unlicensed channel, and transmitting an indication of a shared COT that includes one or more SLSS IDs.

The processor 404 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 404 may be configured to operate a memory array using a memory controller. In some other implementations, a memory controller may be integrated into the processor 404. The processor 404 may be configured to execute computer-readable instructions stored in a memory (e.g., the memory 406) to cause the device 402 to perform various functions of the present disclosure.

The memory 406 may include random access memory (RAM) and read-only memory (ROM). The memory 406 may store computer-readable, computer-executable code including instructions that, when executed by the processor 404 cause the device 402 to perform various functions described herein. The code may be stored in a non-transitory computer-readable medium such as system memory or another type of memory. In some implementations, the code may not be directly executable by the processor 404 but may cause a computer (e.g., when compiled and executed) to perform functions described herein. In some implementations, the memory 406 may include, among other things, a basic I/O system (BIOS) which may control basic hardware or software operation such as the interaction with peripheral components or devices.

The I/O controller 410 may manage input and output signals for the device 402. The I/O controller 410 may also manage peripherals not integrated into the device M02. In some implementations, the I/O controller 410 may represent a physical connection or port to an external peripheral. In some implementations, the I/O controller 410 may utilize an operating system such as iOS®, ANDROID®, MS-DOS®, MS-WINDOWS®, OS/2®, UNIX®, LINUX®, or another known operating system. In some implementations, the I/O controller 410 may be implemented as part of a processor, such as the processor M06. In some implementations, a user may interact with the device 402 via the I/O controller 410 or via hardware components controlled by the I/O controller 410.

In some implementations, the device 402 may include a single antenna 412. However, in some other implementations, the device 402 may have more than one antenna 412 (i.e., multiple antennas), including multiple antenna panels or antenna arrays, which may be capable of concurrently transmitting or receiving multiple wireless transmissions. The transceiver 408 may communicate bi-directionally, via the one or more antennas 412, wired, or wireless links as described herein. For example, the transceiver 408 may represent a wireless transceiver and may communicate bi-directionally with another wireless transceiver. The transceiver 408 may also include a modem to modulate the packets, to provide the modulated packets to one or more antennas 412 for transmission, and to demodulate packets received from the one or more antennas 412.

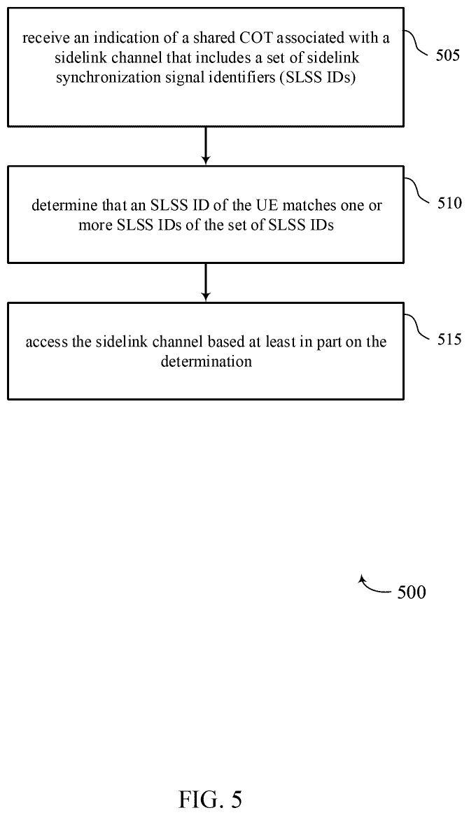

FIG. 5 illustrates a flowchart of a method 500 that supports sharing a COT with a synchronization reference UE in accordance with aspects of the present disclosure. The operations of the method 500 may be implemented by a device or its components as described herein. For example, the operations of the method 500 may be performed by the UE 104 as described with reference to FIGS. 1 through 3B. In some implementations, the device may execute a set of instructions to control the function elements of the device to perform the described functions. Additionally, or alternatively, the device may perform aspects of the described functions using special-purpose hardware.

At 505, the method 500 may include receiving an indication of a shared COT associated with a sidelink channel, where the indication includes a set of SLSS IDs. The operations of 505 may be performed in accordance with examples as described herein. In some implementations, aspects of the operations of 505 may be performed by a device as described with reference to FIG. 1.

At 510, the method 500 may include determining that an SLSS ID of the UE matches one or more SLSS IDs of the set of SLSS IDs. The operations of 510 may be performed in accordance with examples as described herein. In some implementations, aspects of the operations of 510 may be performed by a device as described with reference to FIG. 1.

At 515, the method 500 may include accessing the sidelink channel based at least in part on the determination. The operations of 515 may be performed in accordance with examples as described herein. In some implementations, aspects of the operations of 515 may be performed by a device as described with reference to FIG. 1.

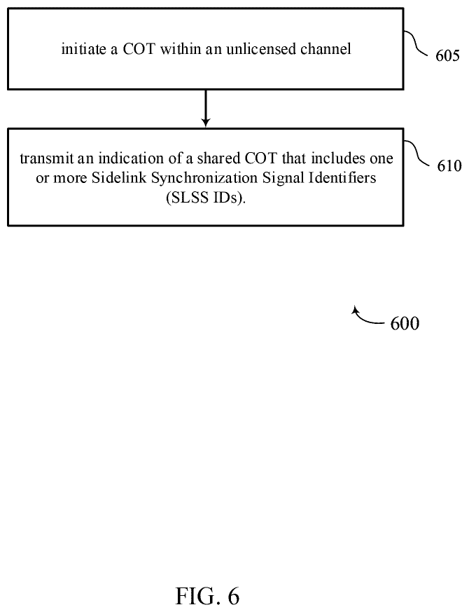

FIG. 6 illustrates a flowchart of a method 600 that supports transmitting information over a shared COT in accordance with aspects of the present disclosure. The operations of the method 600 may be implemented by a device or its components as described herein. For example, the operations of the method 600 may be performed by the UE 104 as described with reference to FIGS. 1 through 3B. In some implementations, the device may execute a set of instructions to control the function elements of the device to perform the described functions. Additionally, or alternatively, the device may perform aspects of the described functions using special-purpose hardware.

At 605, the method 600 may include initiating a COT within an unlicensed channel. The operations of 605 may be performed in accordance with examples as described herein. In some implementations, aspects of the operations of 605 may be performed by a device as described with reference to FIG. 1.

At 610, the method 600 may include transmitting an indication of a shared COT that includes one or more SLSS IDs. The operations of 610 may be performed in accordance with examples as described herein. In some implementations, aspects of the operations of 610 may be performed by a device as described with reference to FIG. 1.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of') indicates an inclusive list such that, for example, a list of at least one of A, B, or C means A or B or C or AB or AC or BC or ABC (i.e., A and B and C). Also, as used herein, the phrase ”based on“ shall not be construed as a reference to a closed set of conditions. For example, an example step that is described as ”based on condition A“ may be based on both a condition A and a condition B without departing from the scope of the present disclosure. In other words, as used herein, the phrase ”based on“ shall be construed in the same manner as the phrase ”based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
one or more memories; and
one or more processors coupled with the one or more memories and individually or collectively configured to cause the UE to:
receive an indication of a shared channel occupancy time (COT) associated with a sidelink channel, wherein the indication includes a set of sidelink synchronization signal identifiers (SLSS IDs);
determine that an SLSS ID of the UE matches one or more SLSS IDs of the set of SLSS IDs; and
access the sidelink channel based at least in part on the determination.

2. The UE of claim 1, wherein the indication of the shared COT is received via a medium access control (MAC) control element, sidelink control information (SCI), or resources within a physical sidelink shared channel (PSSCH).

3. The UE of claim 1, wherein the one or more processors are individually or collectively further configured to cause the UE to:
transmit, over the sidelink channel, one or more sidelink synchronization signal blocks (S-SSBs) or parts thereof; and
access the sidelink channel associated with the shared COT based at least in part on a Type 2 or a sub-type of the Type 2 channel access procedure.

4. The UE of claim 1, wherein the UE is a synchronization reference (SyncRef) UE, and wherein the one or more processors are individually or collectively configured to cause the synchronization reference UE to transmit sidelink synchronization signal blocks (S-SSBs) or parts thereof over the sidelink channel.

5. The UE of claim 4, wherein the indication of the shared COT includes a respective in-coverage indicator (I_{IC}) for each of the one or more SLSS IDs of the set of SLSS IDs, and wherein the one or more processors are individually or collectively configured to cause the UE to access the sidelink channel based at least in part on a match of a combination of the SLSS ID of the UE and an in-coverage indicator (I_{IC}) for the UE to one or more combinations of SLSS IDs and in-coverage indicators (I_{IC}) received in the indication of the shared COT.

6. The UE of claim 1, wherein the UE is an out-of-coverage synchronization reference (SyncRef) UE, and wherein the one or more processors are individually or collectively configured to cause the synchronization reference UE to transmit sidelink synchronization signal blocks (S-SSBs) or parts thereof over the sidelink channel.

7. The UE of claim 1, wherein the indication of the shared COT includes an identifier representing a list of SLSS IDs associated with a set of synchronization reference (SyncRef) UEs authorized to access the sidelink channel for transmission of sidelink synchronization signal blocks (S-SSBs) or parts thereof.

8. The UE of claim 7, wherein the one or more processors are individually or collectively configured to cause the UE to receive a radio resource control (RRC) message comprising the list of SLSS IDs associated with a set of synchronization reference UEs.

9. The UE of claim 1, wherein the indication of the shared COT includes a flag field that indicates whether to access the sidelink channel for transmission of sidelink synchronization signal blocks (S-SSBs) or parts thereof.

10. A method performed by a user equipment (UE), the method comprising:
receiving an indication of a shared channel occupancy time (COT) associated with a sidelink channel,
wherein the indication includes a set of sidelink synchronization signal identifiers (SLSS IDs);
determining that an SLSS ID of the UE matches one or more SLSS IDs of the set of SLSS IDs; and
accessing the sidelink channel based at least in part on the determination.

11. The method of claim 10, wherein the indication of the shared COT is received via a medium access control (MAC) control element, sidelink control information (SCI), or resources within a physical sidelink shared channel (PSSCH).

12. The method of claim 10, further comprising:
transmitting, over the sidelink channel, one or more sidelink synchronization signal blocks (S-SSBs) or parts thereof; and
accessing the sidelink channel associated with the shared COT based at least in part on a Type 2 or a sub-type of the Type 2 channel access procedure.

13. The method of claim 10, wherein the UE is a synchronization reference (SyncRef) UE that transmits sidelink synchronization signal blocks (S-SSBs) or parts thereof over the sidelink channel.

14. The method of claim 10, wherein the UE is an out-of-coverage synchronization reference (SyncRef) UE that transmits sidelink synchronization signal blocks (S-SSBs) or parts thereof over the sidelink channel.

15. The method of claim 10, wherein the indication of the shared COT includes an identifier representing a list of SLSS IDs associated with a set of synchronization reference (SyncRef) UEs authorized to access the sidelink channel for transmission of sidelink synchronization signal blocks (S-SSBs) or parts thereof.

16. The method of claim 10, further comprising:
receiving a radio resource control (RRC) message comprising the list of SLSS IDs associated with a set of synchronization reference (SyncRef) UEs.

17. A user equipment (UE) for wireless communication, comprising:
one or more memories; and
one or more processors coupled with the one or more memories and individually or collectively configured to cause the UE to:
initiate a channel occupancy time (COT) within an unlicensed channel; and
transmit an indication of a shared COT that includes one or more Sidelink Synchronization Signal Identifiers (SLSS IDs).

18. The UE of claim 17, wherein the indication of the shared COT includes a respective in-coverage indicator (I_{IC}) for each of the one or more SLSS IDs of the set of SLSS IDs.

19. The UE of claim 17, wherein the indication of the shared COT includes an identifier that represents a list of SLSS IDs associated with synchronization reference (SyncRef) UEs authorized to access the COT for transmission of sidelink synchronization signal blocks (S-SSBs) or parts thereof.

20. (canceled)

21. A method performed by a user equipment (UE), the method comprising:
initiating a channel occupancy time (COT) within an unlicensed channel; and
transmitting an indication of a shared COT that includes one or more Sidelink Synchronization Signal Identifiers (SLSS IDs).
